(19) United States
(12) Patent Application Publication
(10) Pub. No.: US 2006/0244519 A1
(43) Pub. Date: Nov. 2, 2006

(54) Digitally controlled uniform step size CTF

(75) Inventors: Namik Kemal Kocaman, Irvine, CA (US); Afshin Momtaz, Laguna Hills, CA (US)

Correspondence Address: CHRISTIE, PARKER & HALE, LLP, PO BOX 7068, PASADENA, CA, 91109-7068, US

(73) Assignee: Broadcom Corporation, Irvine, CA (US)

(21) Appl. No.: 11/116,160

(22) Filed: Apr. 27, 2005

(51) Int. Cl. G01M 11/00

(52) U.S. Cl. 327/552

(57) ABSTRACT

A continuous time filter having a first stage and a second stage. A first stage adjusts a bandwidth of the signal. A second stage adjusts bandwidth of the signal subsequent to the first stage. Each stage includes a first capacitor with a first capacitance and a second capacitor with a second capacitance for providing uniform step sizes for bandwidth adjustment. The continuous time filter may include a plurality of cascaded stages including the first stage and the second stage. In addition, a bandwidth adjustment across the first stage and the second stage may be controlled using a semi-interleaved thermometer coding to achieve a cascaded effect for the bandwidth adjustment.

### FIELD OF THE INVENTION

The present invention relates to a bandwidth adjustment scheme, and more particularly to a bandwidth adjustment scheme using a continuous time filter (CTF).

### BACKGROUND OF THE INVENTION

In many signal conditioning systems especially communication links, received information bearing signals are subject to bandwidth adjustment using a continuous time filter (CTF).

Bandwidth adjustment of an incoming signal is needed because if the bandwidth of the path is kept too low or is limited, then the incoming signal may exhibit inferior quality due to inter-symbol interference (ISI). If the bandwidth of the path is kept too high or is in excess, then excess noise may be added to the incoming signal.

As such, it is desirable to devise a bandwidth adjustment scheme using a single CTF stage and/or a plurality of CTFs stages that are adaptive. An adaptive bandwidth adjustment scheme is especially desired in equalization systems for finding the optimal bandwidth.

### SUMMARY OF THE INVENTION

A system and/or method for providing bandwidth adjustment scheme using a digitally controlled, continuous time filter (CTF) suitable for high bandwidth applications with wide and uniform step bandwidth adjustment range, substantially as shown in and/or described in connection with at least one of the figures, as set forth more completely in the claims.

### BRIEF DESCRIPTION OF THE DRAWINGS

The accompanying figures, together with the specification, illustrate exemplary embodiment(s) of the present invention, and, together with the description, serve to explain the principles of the present invention.

FIG. 1A is a diagram of one embodiment of a continuous time filter circuit (CTF).

FIG. 1B is a diagram of one embodiment of a CTF half circuit.

FIG. 2 is a diagram of one embodiment of a combined CTF and variable gain amplifier (VGA) circuit having several cascaded or M number of stages.

FIG. 3 is a diagram of one embodiment of a multi-stage CTF.

FIG. 4 is a diagram of one embodiment of a multi-stage CTF and VGA circuit having six stages.

FIG. 5 is a diagram of one embodiment of a cell of a multi-stage CTF and VGA circuit.

FIG. 6 is a diagram of one embodiment of an implementation topology for a load impedance.

FIG. 7 is a diagram of one embodiment of a CTF circuit with multiple switchable capacitors.

FIG. 8 is a diagram of one embodiment of a switchable capacitor structure.

### DETAILED DESCRIPTION

Exemplary embodiments of the invention provide a bandwidth adjustment scheme using a digitally controlled, continuous time filter (CTF) suitable for high bandwidth applications with wide and uniform step bandwidth adjustment range. In certain embodiments, a digitally adjusted CTF is provided using switchable capacitors and/or a plurality of CTF stages that are cascaded one after another.

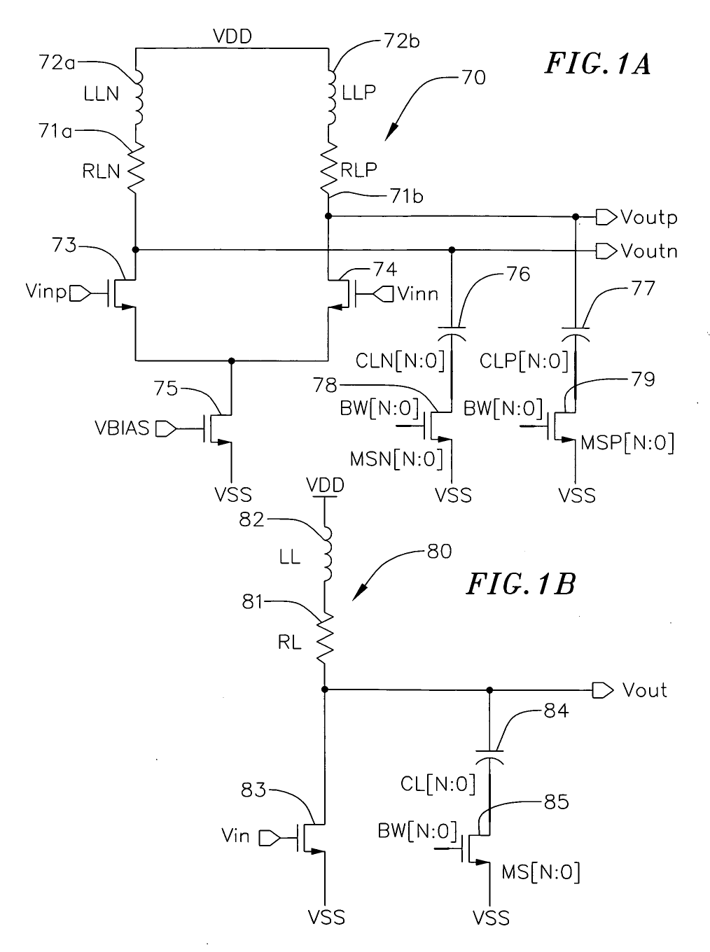

A CTF cell can be implemented as shown in FIG. 1A as a CTF circuit 70. FIG. 1B is a CTF half-circuit 80 corresponding to the CTF circuit 70. The CTF circuit 70 is a differential current mode logic (CML) circuit with an array of N+1 programmable capacitors CLP[N:0] 77 connected in parallel at a positive output node Voutp and an array of N+1 programmable capacitors CLN[N:0] 76 connected in parallel at a negative output node Voutn, to set the bandwidth. The programmable capacitors CLP[N:0] 77 and CLN[N:0] 76 receive an array of N+1 control signals over BW[N:0], which is a control bus having a bus signal width N+1.

The programmable capacitors 76, 77 are coupled to a ground voltage or a voltage VSS through switches (or transistors) MSN[N:0] 78 and switches (or transistors) MSP[N:0] 79, respectively. The CTF circuit 70 also includes load resistors 71a, 71b, load inductors 72a, 72b, input transistors 73, 74, and a current source transistor 75. The load resistors 71a, 71b and the load inductors 72a, 72b are respectively connected in series and are respectively coupled to the output nodes Voutn, Voutp with respective programmable capacitors 76, 77 to thereby make up the load impedances ZLOAD of the differential CTF circuit 70. The current source transistor 75 receives a bias voltage VBIAS at its gate. In one exemplary embodiment, N is equal to 14. Hence, there are fifteen each of the programmable capacitors 76, 77 and the switches 78, 79. The number of programmable capacitors and switches may be the same or different in other exemplary embodiments of the present invention.

Similar to the CTF circuit 70 of FIG. 1A, the CTF half-circuit 80 is a CML half-circuit with programmable capacitors CL[N:0] 84 connected at the output node Vout to set the bandwidth. The programmable capacitors 84 are coupled to a ground voltage VSS through switches MS[N:0] 85. The CTF circuit 80 has a load resistor RL 81 and a load inductor LL 82 coupled to a supply voltage VDD. The load resistor 81 and the load inductor 82 are connected in series and are coupled to the output node Vout with the programmable capacitors 84 to thereby make up the load impedance ZLOAD of the CTF circuit 80. The CTF circuit 80 receives an input voltage Vin at a gate of an input transistor 83. The transfer function of the CTF half-circuit 80 is shown in Equation 1 below. In Equation 1, the trans-conductance is represented by gm (e.g., the trans-conductance of input transistor 83) and the capacitance CL is programmable through varying the number of capacitors CL[N:0] 84 that are connected to the ground voltage VSS by turning on the corresponding ones of the switches MS[N:0].

$$\frac{Vout}{Vin} = gm \cdot \frac{{R}_{L} + jω {L}_{L}}{1 + jω {R}_{L} {C}_{L} + {( jω )}^{2} {L}_{L} {C}_{L}} \qquad ( Eq . 1 )$$

As such, the bandwidth of the transfer function(or

$$\frac{Vout}{Vin}$$

is inversely proportional with CL (or C_{L}).

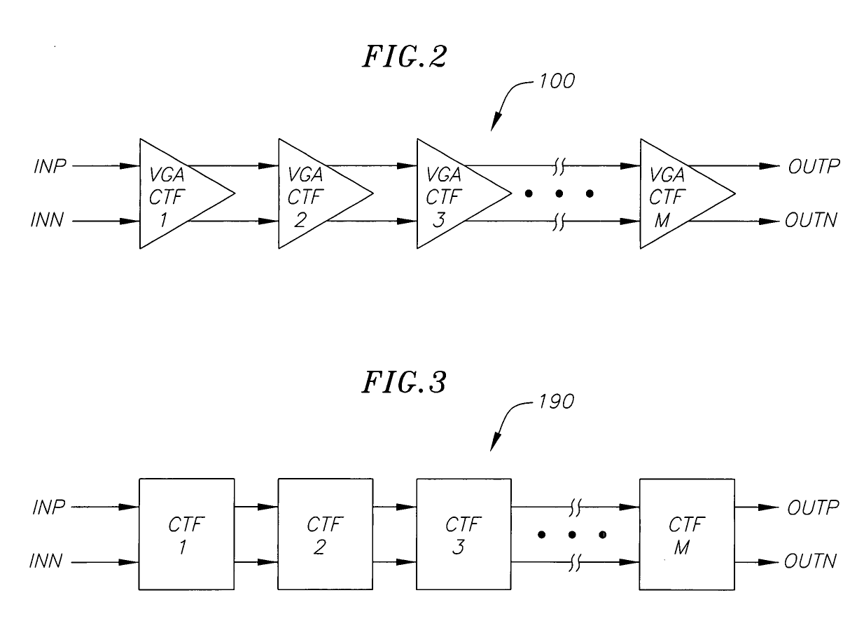

In an exemplary embodiment, a CTF is combined with a variable gain amplifier (VGA). Depending on the amount of gain, attenuation, and/or bandwidth limitation desired, a VGA-CTF combination circuitry 100 can have several VGA-CTF stages cascaded one after another as shown in FIG. 2. Similarly, depending on the bandwidth limitation desired, several CTF cells (or stages) may be cascaded one after another as shown in cascaded CTF circuitry 190 of FIG. 3. The cascaded CTF circuitry 190 of FIG. 3 may be embedded in one or more stages of the VGA-CTF combination circuitry 100; however, the present invention is not thereby limited. For example, a particular topology may have several stages of VGA cascaded one after another followed by several cells (or stages) of CTF cascaded one after another.

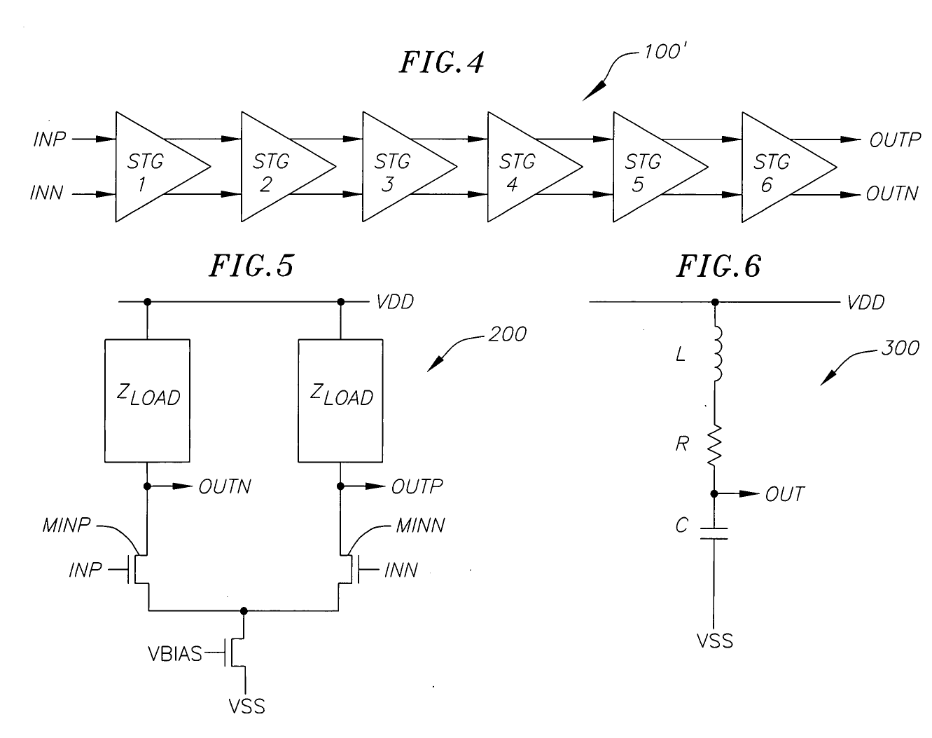

In more detail, a VGA-CTF combination circuitry 100′ of FIG. 4 is shown to have six (6) cascaded stages that can be utilized for signal amplification. However, the present invention is not thereby limited. For example, without loss of generality, any number of stages can be utilized to achieve the desired specifications such as gain, bandwidth, power consumption, and/or substrate (or silicon) area. Moreover, without loss of generality, the present invention is not limited to a CTF that is combined with a VGA. For example, the CTF can be combined in and/or with other type of gain amplifiers, differential pairs, or source followers.

As is shown in FIG. 5, each stage 200 of an exemplary combination circuitry (e.g., the VGA-CTF combination circuitry 100′ of FIG. 4) includes a differential pair of input transistors Minp, Minn. As is known to those skilled in the art, the trans-conductance (gm) provided by input transistor Minp, Minn multiplied by the load impedance ZLOAD gives the gain per stage 200. In one embodiment of the present invention, a CTF circuitry is embedded into each of the cascaded gain stages of the VGA-CTF combination circuitry 100′ of FIG. 4 as a variable capacitance portion C of ZLOAD.

Referring to FIG. 6, an implementation topology 300 for a load impedance ZLOAD can include a resistance portion R, an inductance portion L, and a capacitance portion C. The resistance portion R and the inductance portion L are connected in series and are coupled to the output node OUT with the capacitance portion C. Because of this implementation topology 300, variable or switchable resistance R, variable or switchable inductance L, and/or variable or switchable capacitance C structures can be utilized to further enhance a control on gain range as well as bandwidth.

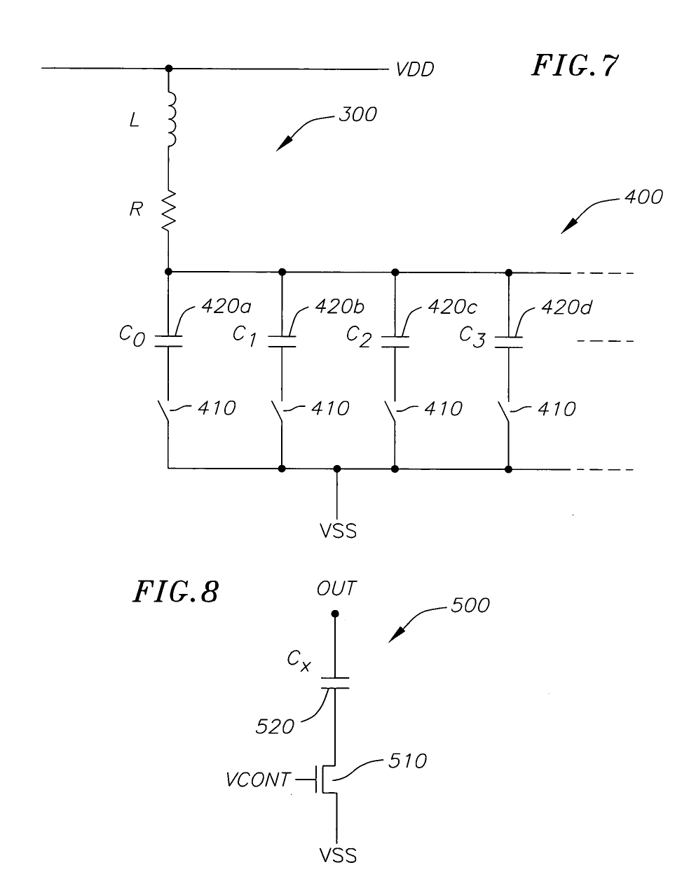

Referring to FIG. 7, a circuit structure 400 of an embodiment of the present invention uses a plurality of switchable capacitors 420a, 420b, 420c, 420d, etc. having respective capacitances C0, C1, C2, C3, etc., to realize the variable capacitance portion C of the ZLOAD shown in FIG. 6. In FIG. 7, the switchable capacitors 420a, 420b, 420c, 420d, etc. are switchable because they each include a switch 410 coupled to the capacitors 420 with respective capacitances C0, C1, C2, C3, etc. In one embodiment, the respective capacitances C0, C1, C2, C3, etc. are different from each other with increasing capacitance values so that they can provide for uniform bandwidth step sizes. That is, to provide for uniform bandwidth step sizes, C1 should be greater than C0, C2 should be greater than C1, C3 should be grater than C2, etc.

In particular and referring to FIG. 8, a switchable capacitor structure 500 of the variable capacitance portion C of the ZLOAD in an exemplary embodiment includes a control voltage VCONT coupled to a gate of a switching transistor 510. An electrode (e.g., a source or a drain) of the switching transistor 510 is in turn coupled to a capacitor 520 having a capacitance Cx (e.g., the capacitance C0, C1, C2, C3, etc shown in FIG. 7) to selectively switch the capacitor 520 ON or OFF. For example, in one embodiment, the transistor 510 is an NMOS transistor and is turned ON when the voltage VCONT is at a high level, which corresponds to capacitance Cx being ON. On the other hand, when the control voltage VCONT is turned to a LOW level, there is no conduction path from the capacitance Cx to ground due to the transistor 510 being turned OFF and the capacitance Cx is now switched OFF. It should be noted that a low voltage transistor should be used as the switching transistor 510 to achieve a minimum resistance when it is turned ON. This minimum transistor resistance will improve the high frequency quality factor of the capacitance as well as the density of the capacitance per unit area. In addition, the HIGH level of the voltage VCONT should be limited due to reliability requirements of a low voltage transistor. Moreover, in other embodiments, any other suitable transistors may be used as the switching transistors and/or input transistors (e.g., to replace one or more NMOS transistors specified herein with one or more PMOS transistors).

In further exemplary embodiments of the present invention, a scheme has been implemented to achieve monotonic and uniform step size for bandwidth adjustment. The scheme includes (1) employing a semi-interleaved thermometer coding method to control various CTF stages that are cascaded one after another (e.g., the cascaded stages of FIG. 4) to achieve a cascaded effect for changing overall bandwidth using reduce amount of overall capacitance and (2) using variable capacitor sizes as shown in FIG. 7 to achieve uniform step size for bandwidth adjustment.

Semi-Interleaving Cascaded CTF Stages

Referring back to FIG. 4, in one embodiment of the present invention, the semi-interleaved thermometer coding method is used to control the CTF stages that are cascaded one after another by grouping these cascaded stages into two subsets A, B:

SUBSET A includes STAGES 1, 2, and 3; and

SUBSET B includes STAGES 4, 5, and 6.

However, the present invention is not thereby limited to grouping into just two subsets. Without loss of generality, an exemplary embodiment can be arranged into any number of subsets having any number of combined CTF control signals to control all the stages separately, individually, or a combination there between (e.g., as two subsets A, B). The control arrangement depends on the desired step size for the CTF. That is, if all the stages are controlled separately, it corresponds to smallest step size for the CTF. If all the stages are controlled together in one set, it corresponds to largest step size. The semi-interleaved thermometer coding method of an exemplary embodiment uses the two subsets to provide a desired step size that is between the smallest step size and the largest step size for an exemplary application.

In more detail, assuming k=15 parallel capacitors are being used at the output of each cascaded stage of FIG. 4, the two subsets correspond to 2k+1=31 of CTF settings. In particular, Table 1 below can be used to visualize how CTF capacitors are turned ON or OFF using the semi-interleaved thermometer coding method of the present invention.

TABLE 1
Number of capacitances ON versus CTF Setting
(1-31) where k = 15

| CTF SETTING | SUBSETA | SUBSETB |
|---|---|---|
| 1 | 0 | 0 |
| 2 | 1 | 0 |
| 3 | 1 | 1 |
| 4 | 2 | 1 |
| 5 | 2 | 2 |
| 6 | 3 | 2 |
| . | . | . |
| . | . | . |
| . | . | . |
| 30 | 15 | 14 |
| 31 | 15 | 15 |

In view of the foregoing and using the interleaved or the semi-interleaved thermometer coding method of Table 1 to control the cascaded CTF stages, the overall capacitance (and/or the capacitance per stage) is reduced as compared with a conventional system. That is, to provide a desired bandwidth range, the scheme using a plurality of CTF stages that are cascaded one after another requires less capacitance than a signal that is processed by a single CTF stage due to a cascaded capacitance effect. As known to those who are skilled in the art, cascaded CTF stages will exhibit higher order roll off in the bandwidth compared to a single stage CTF. Higher order roll off in bandwidth will require less capacitance to achieve the desired bandwidth range.

Variable Capacitor Sizes

Referring now back to FIG. 7, uniform step size for bandwidth adjustment can be achieved in an exemplary embodiment of the present invention because the embodiment uses variable capacitor sizes (or variable capacitances) provided through the circuit structure 400 having the 15 parallel capacitors 420a, 420b, 420c, 420d, etc. That is, if the total capacitance increases at the output of each stage, more and more capacitance value should be turned ON to keep the bandwidth step in a relatively constant manner. The exemplary embodiment provides uniform bandwidth step size by turning ON more and more capacitors 420a, 420b, 420c, 420d, etc. respectively having more and more capacitances C0, C1, C2, C3, etc. that are connected in parallel.

In general, since a CTF circuitry of an exemplary embodiment has a plurality of cascaded stages that are controlled using an interleaved or a semi-interleaved thermometer coding method, the CTF circuitry is able to use a less overall switchable capacitance, and hence fewer switches and/or less routings are required.

In addition, a CTF circuitry of an exemplary embodiment uses non-uniform capacitance values as opposed to fixed capacitance values to provide a more uniform step size for bandwidth adjustment.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A continuous time filter, comprising:
a first stage for adjusting a bandwidth of a signal; and
a second stage for adjusting the bandwidth of the signal subsequent to the first stage,
wherein each stage comprises a first capacitor having a first capacitance and a second capacitor having a second capacitance for providing substantially uniform step sizes for bandwidth adjustment.

2. The continuous time filter of claim 1, wherein each stage further comprises an inductor and a resistor and wherein the first capacitor and the second capacitor are connected to the inductor and the resistor in parallel.

3. The continuous time filter of claim 1, wherein a bandwidth adjustment across the first stage and the second stage is controlled using an interleaved thermometer coding.

4. The continuous time filter of claim 1, wherein a bandwidth adjustment across the first stage and the second stage is controlled using a semi-interleaved thermometer coding.

5. The continuous time filter of claim 1, wherein the first capacitor and the second capacitor are separately enabled.

6. The continuous time filter of claim 1, wherein the second capacitance is larger than the first capacitance.

7. The continuous time filter of claim 6, wherein, to provide a first adjustment step, the first capacitor and the second capacitor are both not enabled, wherein, to provide a second adjustment step, the second capacitor is not enabled and the first capacitor is enabled, wherein, to provide a third adjustment step, the first capacitor and the second capacitor are both enabled, and wherein a size of bandwidth adjustment from the first adjustment step to the second adjustment step is substantially equal to a size of bandwidth adjustment from the second adjustment step to the third adjustment step.

8. The continuous time filter of claim 6, further comprising a first transistor for enabling the first capacitor and a second transistor for enabling the second capacitor.

9. The continuous time filter of claim 1, further comprising a plurality of cascaded stages, wherein the plurality of cascaded stages include the first stage and the second stage.

10. A device comprising:
a cascaded variable gain amplifier to adjust a gain of an input signal; and
a cascaded continuous time filter for adjusting a bandwidth of the input signal,
wherein a step size of the continuous time filter is set using a semi-interleaved thermometer coding.

11. The device of claim 10, wherein the cascaded continuous time filter comprises:
a first stage comprising a plurality of separately switchable capacitors.

12. The device of claim 10, wherein the cascaded continuous time filter comprises:
a first capacitor having a first capacitance; and
a second capacitor having a second capacitance, the second capacitance being larger than the first capacitance.

13. The device of claim 10, wherein the cascaded continuous time filter comprises a plurality of cascaded stages and wherein the cascaded stages are divided into a plurality of subsets, each subset being separately controlled, the subsets determining a plurality of step sizes of the cascaded continuous time filter.

14. The device of claim 10, wherein the semi interleaved thermometer coding progressively enables more capacitors having respectively more capacitances to maintain uniformity among the step sizes.

15. The device of claim 10, wherein the cascaded continuous time filter is embedded in a plurality of stages in the cascaded variable gain amplifier.

16. A device comprising:
a first circuit comprising a first set of switchable capacitors to adjust a bandwidth of an input signal; and
a second circuit comprising a second set of switchable capacitors to adjust a bandwidth of an output from the first circuit,
wherein the first set of capacitors have a range of capacitances to enable uniform bandwidth adjustment step sizes.

17. The device of claim 16, further comprising:
a third circuit coupled to the first circuit to adjust a gain of the input signal.

18. The device of claim 16, wherein a bandwidth adjustment across the first stage and the second stage is controlled using a semi-interleaved thermometer coding.

19. The device of claim 16, wherein each of the capacitors in the first set are separately switchable.

20. The device of claim 16, wherein the first set and the second set of switchable capacitors are grouped to be enabled using a semi-interleaved thermometer coding.

21. The device of claim 20, wherein, to enable the uniform bandwidth adjustment step sizes, the semi interleaved thermometer coding progressively enables more capacitance for each bandwidth adjustment step.

22. The device of claim 16, wherein the first circuit is embedded into a third circuit, the third circuit adjusting a gain of the input signal.
